(19) United States
(12) Patent Application Publication
(10) Pub. No.: US 2008/0129447 A1
(43) Pub. Date: Jun. 5, 2008

(54) Electronic tag for protecting privacy and method of protecting privacy using the same

(75) Inventors: Doo Ho Choi, Cheonan (KR); Ju Han Kim, Daejeon (KR); Ho Won Kim, Daejeon (KR); Kyo Il Chung, Daejeon (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/893,496

(22) Filed: Aug. 16, 2007

(30) Foreign Application Priority Data
Dec. 4, 2006 (KR) 10-2006-0121815

(51) Int. Cl. G08C 17/02

(52) U.S. Cl. 340/5.61

(57) ABSTRACT

An electronic tag for protecting privacy in RFID and a method of protecting privacy using the same are provided. Specifically, an RFID electronic tag capable of protecting privacy by authenticating an RFID reader and controlling access of the RFID reader to the RFID tag and a method of protecting privacy using the same are provided. The RFID electronic tag is applicable to a passive type RFID tag. The RFID electronic tag is also applicable to an ISO/IEC 18000-6 Type C tag that is a typical passive type RFID tag. It is possible to protect privacy of a user by controlling access of the RFID reader to the RFID tag and authenticating the RFID reader by modifying a tag inventory protocol and a memory map of the tag.

### CROSS-REFERENCE TO RELATED PATENT APPLICATION

This application claims the benefit of Korean Patent Application No. 10-2006-0121815, filed on Dec. 4, 2006, in the Korean Intellectual Property Office, the disclosure of which is incorporated herein in its entirety by reference.

### BACKGROUND OF THE INVENTION

1. Field of the Invention

The present invention relates to an electronic tag for protecting privacy in a radio frequency identification (RFID) technique and a method of protecting privacy using the same, and more particularly, to an electronic tag for protecting the privacy of a user and protecting RFID tag data against being traced and exposed by controlling access of an RFID reader to the RFID tag and authenticating the RFID reader.

2. Description of the Related Art

Radio frequency identification (RFID) is a technique which serves to read and trace an object including a chip. The chip is obtained by inserting identification information into a subminiature semiconductor using a radio frequency.

RFID serves to manage information by attaching an RFID tag to a desired object or place, sensing all the information of the surroundings of the RFID tag on the basis of recognition information of the desired object or place, and transmitting the information to a network in real time.

In a communication network using RFID, first, RFID that provides recognition information is developed. Then a sensing function is added thereto, and a Ubiquitous Sensor Network (USN) type network is developed therebetween.

That is, when RFID is introduced into a circulation system and a physical distribution system, information stored in RFID tags, which are attached to products by a manufacturer, automatically informs workers which vehicle the products are to be loaded into, when the products are taken out of the warehouse.

When the products to which the RFID tags are attached arrive by vehicle, the management system recognizes the products to which RFID tags are attached, and thus the management system can automatically check the product items and number of product items and deliver the products. Through the aforementioned process, when a buyer buys a product at a store, it is possible to automatically recognize the amount of stock corresponding to the amount of stock bought by the buyer.

After a user buys a product, when the product belonging to the user experiences a fault, a fault diagnosis and the time at which the fault occurred are searched for, and the user may be previously informed of a replacement product. In other words a tailored, on-demand service is provided to the user.

In addition, the user is informed that the product is genuine. Since the user can also check the steps in the supply chain of the product, it is possible to improve service quality.

However, in an automated environment in which information is easily obtained, serious problems in security may occur. When the RFID tag is used, privacy of the user, such as location information on the product to which the RFID tag is attached and buying history, is seriously threatened.

For example, it is possible to easily reveal information corresponding to privacy such as information on a place where the product is sold, other products which are bought by the buyer who buys the product, and a place where the product is used.

The ID of the RFID tag is easily identified and the tag responds to the reader automatically and unconsciously. Thus, security is seriously threatened in the automated RFID/USN environment in which information is easily obtained.

In particular, since the RFID reader can read a code value stored in the passive type RFID tag (for example, ISO/IEC 18000-6 Type C tag) at any time without limitation, privacy invasion such as tracing of product information and location information through the RFID tag code easily occurs. In addition, the tags have been easily counterfeited or altered.

However, it is difficult to employ existing information protection techniques due to limited resources such as the capacity of an embedded memory used for RFID. Furthermore, it is expected that attacks widely occur with respect to various objects instead of with respect to each person.

In the USN environment, objects to be attacked include total personal information such as information on objects and information on a user's body in addition to information stored in a computer or communication information. The attack range includes all the personal spaces in addition to a personal computer.

Since the range of damage caused by attacks can be easily extended, and attacks are easy to execute due to the USN environment, there is a great need for a method of solving the problem of personal privacy invasion. Personal privacy guidelines have already been defined.

Other than the aforementioned method, there is provided a method of suppressing recycling of the RFID tag by preventing RFID readers from accessing data. In this method, a kill command is used after buying a product to which an RFID tag is attached to prevent readers from accessing data. However, the method departs from the spirit of providing convenience to a user by applying the electronic tags to the industries.

Accordingly, in the field in which the electronic tag including RFID is currently used, there is no basic solution other than legal or legislative systems for protecting personal privacy. Thus, there is a problem that the unsafe situation will worsen.

### SUMMARY OF THE INVENTION

In order to solve the problem of privacy invasion in an RFID tag, the object of the present invention is to protect RFID tag data and privacy by allowing the RFID tag to transmit a code value stored therein to only an authorized RFID reader.

According to an aspect of the present invention, there is provided an electronic tag for transmitting information stored therein as a signal in a predetermined frequency band, the electronic tag comprising a privacy flag having a predetermined bit string value which is used to allow the information stored in the electronic tag to be accessed when the electronic tag receives a predetermined access password and the received password matches a previously stored password.

According to another aspect of the present invention, there is provided an electronic tag, which transmits information stored therein as a signal in a predetermined frequency band, comprising: an authentication parameter which is used to determine whether authority to access information stored in the electronic tag exists; and an authentication password which corresponds to the authentication parameter.

According to another aspect of the present invention, there is provided a method of protecting privacy using an electronic tag, the method comprising: (a) setting a privacy flag including a predetermined bit string value for allowing the information stored in the electronic tag to be accessed according to a received predetermined command; (b) determining whether authority to access the information stored in the electronic tag exists; and (c) transmitting the information stored in the electronic tag.

According to another aspect of the present invention, there is provided a method of protecting privacy using an electronic tag which transmits information stored therein as a signal in a predetermined frequency bandwidth, the method comprising: setting an authentication parameter, which is used to determine whether authority to access, and an authentication password, which corresponds to the authentication parameter; determining whether the authority to access the information stored in the electronic tag exists by examining whether a received authentication password value matches the set authentication password value; and transmitting the information stored in the electronic tag.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a mobile RFID service network;

FIG. 2 illustrates a logical structure of a memory of an RFID tag to which a method of protecting privacy according to an embodiment of the present invention can be applied;

FIG. 3 illustrates a method of protecting privacy using a tag including a privacy flag according to an embodiment of the present invention;

FIG. 4 illustrates changes of locked states in UII, TID, USER memory regions in a method of protecting privacy using a tag including a privacy flag according to an embodiment of the present invention;

FIG. 5 illustrates a change of a state transition diagram (or state diagram) when a privacy flag according to an embodiment of the present invention is added;

FIG. 6 illustrates a method of protecting privacy using an authentication password according to another embodiment of the present invention;

FIG. 7 illustrates a structure of a memory of a tag in which an authentication parameter and an authentication password are extended in a method of protecting privacy using an authentication password according to another embodiment of the present invention;

FIG. 8 illustrates a change of a state transition diagram (or a state diagram) in a method of protecting privacy using an authentication password according to another embodiment of the present invention;

FIG. 9 is a flowchart illustrating a method of protecting privacy using a tag including a privacy tag according to an embodiment of the present invention; and

FIG. 10 is a flowchart illustrating a method of protecting privacy using an authentication password according to another embodiment of the present invention.

### DETAILED DESCRIPTION OF THE INVENTION

Now, preferred embodiments of the present invention will be described in detail with reference to the attached drawings.

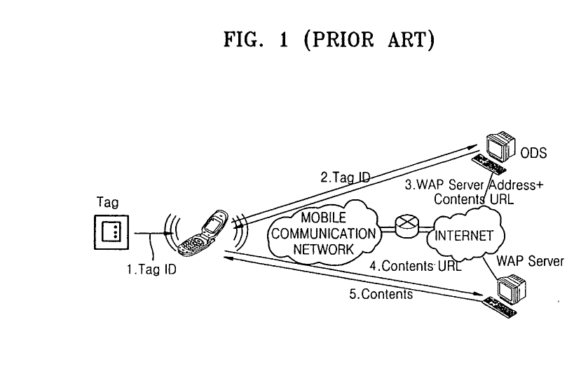

FIG. 1 illustrates a structure of a mobile RFID service network.

Mobile RFID serves to provide various services through a mobile communication network by using a small RFID reader mounted on a mobile phone or the like, when the mobile phone reads an RFID tag.

The mobile phone on which the RFID reader is mounted reads an attached tag for a mobile RFID service, requests an object directory service (ODS) server, which includes mapping information of a tag ID and a uniform resource locator (URL), to provide the URL of content by using information on the tag.

The ODS server returns the URL of the content. The mobile phone requests the content server of the content to provide the content using the returned URL.

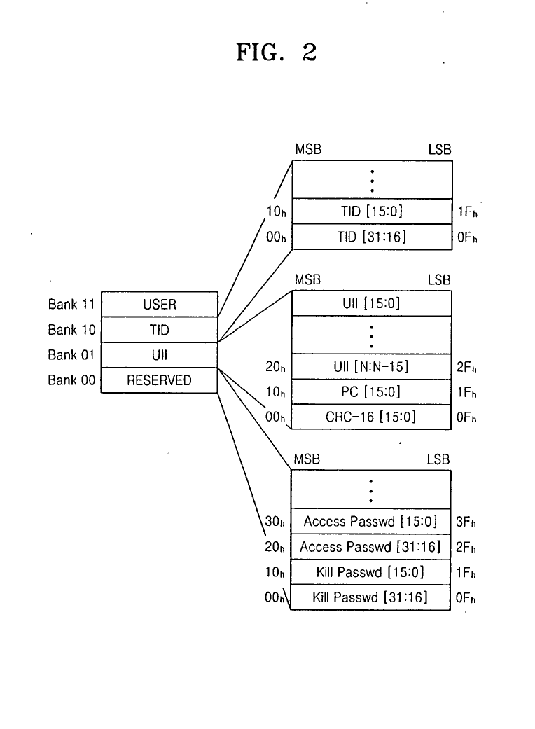

FIG. 2 illustrates a logical structure of a memory of an RFID tag to which a method of protecting privacy according to an embodiment of the present invention can be applied.

FIG. 2 illustrates a structure of a memory of an ISO 18000-6 TYPE C tag.

The memory of the TYPE C tag is divided into four physical blocks.

Bank 11 indicates an application data region. Bank 10 indicates a tag ID region.

Bank 01 indicates an ID region of an item. The Bank 01 is stored as a Unique Item Identifier (UII) code.

Bank 00 is a reserved region. A kill password serves to perform a permanent stop function. An access password serves to perform a lock function.

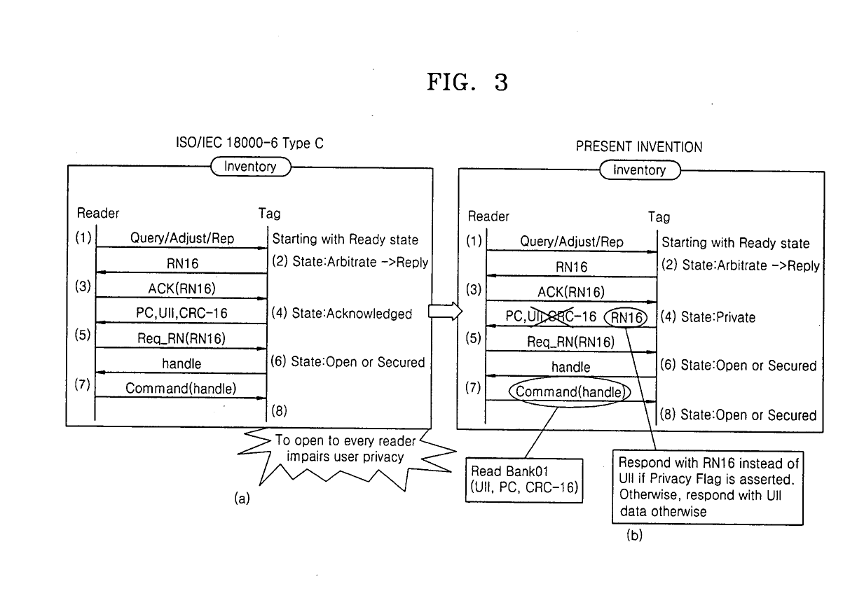

FIG. 3 illustrates a method of protecting privacy using a tag including a privacy flag according to an embodiment of the present invention.

The method of protecting privacy according to an embodiment of the present invention adds a privacy tag so as to allow only an authorized RFID reader to access the RFID tag and reads the code stored therein.

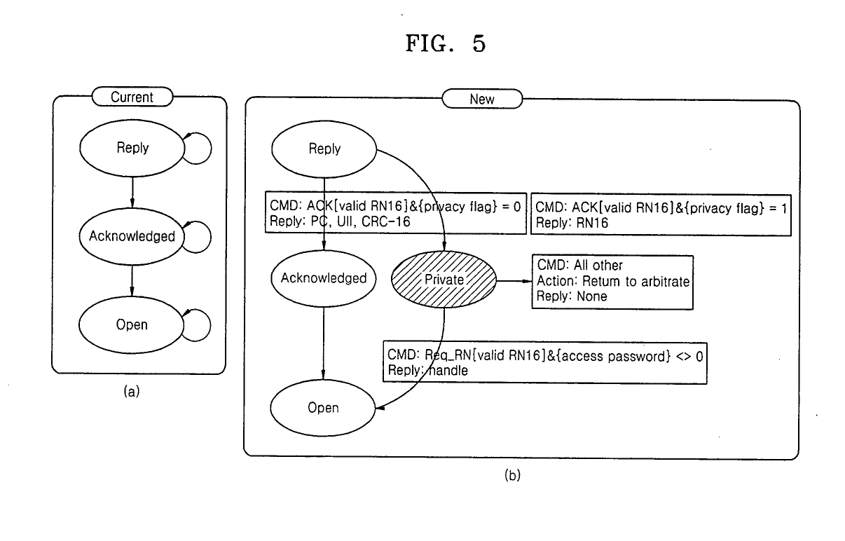

When the privacy flag is added, there exists a Private state in a process of recognizing a tag unlike a process used to recognize an existing passive type RFID tag (for example, ISO/IEC 18000-6 Type C tag) (FIG. 5).

In the method of protecting privacy by adding a privacy flag according to an embodiment of the present invention, the privacy flag is added to the tag, and to commands for setting and canceling the privacy flag in the reader.

Commands for setting and canceling the privacy flag have to be executed by using the access password when the tag is in a secured state.

(a) and (b) of FIG. 3 illustrate a difference in a communication process between a reader and a tag according to whether a privacy tag is added or not.

(a) of FIG. 3 illustrates a communication process between the reader and the tag when the privacy flag is not set.

(1) The RFID reader transmits an inventory command (Query, QueryAdjust, and QueryRep) to the tag in a Ready state.

(2) When a slot-counter value of the tag is 0(RN16), the state of the tag changes from an Arbitrate state to a Reply state. When the slot-counter value is not 0, the tag waits for the QueryAdjust or QueryRep command of the reader.

(3) The RFID reader recognizes the tag as a random number value received in (2).

(4) The tag transmits a Protocol control (PC), a UII, and a CRC-16 to the reader. The state of the tag changes from the Reply state to an Acknowledged state.

(5) The RFID reader transmits a command Req_RN for requesting the tag to provide a new RN16 value in (2) to the tag.

(6) The tag transmits ‘handle’ in response to the request Req_RN of the reader. The state of the tag changes from the Acknowledged state to the Open or Secured state.

(7) The reader accesses the tag using ‘handle’ as a parameter.

(b) of FIG. 3 illustrates a communication process between the reader and the tag when the privacy flag is set.

(1) The RFID reader transmits an inventory command (Query, QueryAdjust, and QueryRep) to the tag in a Ready state.

(2) When a slot-counter value of the tag is 0(RN16), the state of the tag changes from an Arbitrate state to a Reply state. When the slot-counter value is not 0, the tag waits for the QueryAdjust or QueryRep command of the reader.

(3) The RFID reader recognizes the tag as a random number value received in (2).

(4) The tag in which the privacy flag is set transmits a value such as the RN16 value in (2). The state of the tag changes from the Reply state to the Private state.

(5) The RFID reader transmits a command Req_RN for requesting the tag to provide a new RN16 value in (2) to the tag.

(6) The tag transmits ‘handle’ in response to the Req_RN request of the reader. The tag state changes from the Private state to the Open state (when the privacy flag is set, the access password is required).

(7) The reader accesses the tag using ‘handle’ as a parameter. The reader allows the state of the tag to change to the Secured state using the access password and reads the PC, UII, and CRC-16 values of the tag in response to a command for reading the tag.

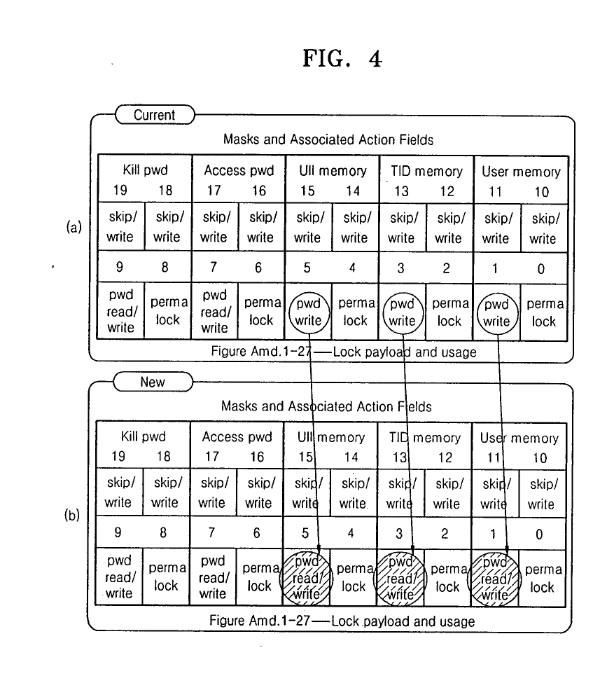

FIG. 4 illustrates changes of locked states in UII, TID, and USER memory regions in a method of protecting privacy using a tag including a privacy flag according to an embodiment of the present invention;

When the privacy flag according to an embodiment of the present invention is set, a random value (RN16) instead of the PC, the UII, and the CRC-16 is transmitted to the RFID reader with respect to the inventory protocol (the process of (4) of (b) of FIG. 3).

When the privacy flag is not set, the PC, the UII, and the CRC-16 are transmitted to the reader with respect to the inventory protocol (the process of (4) of ISO 18000-6 TYPE C of (a) of FIG. 3).

In order to use the privacy flag, write functions of a UII memory, a TID memory, and a user memory ((a) of FIG. 4), which are allowed through passwords, have to be extended to read and write functions.

FIG. 5 illustrates a change of a state transition diagram (or state diagram) when a privacy flag according to an embodiment of the present invention is added.

When the privacy flag is not set as shown in (a) of FIG. 5, the reader can access the information on the tag by allowing the tag to pass through states of (1) Ready, (2) Arbitrate, (3) Replay, (4) Acknowledged, and (5) Open or Secured.

However, when the privacy flag according to an embodiment of the present invention is set as shown in (b) of FIG. 5, the reader can access the information on the tag by allowing the tag to pass through states of (1) Ready, (2) Arbitrate, (3) Replay, (4) Private, and (5) Open or Secured.

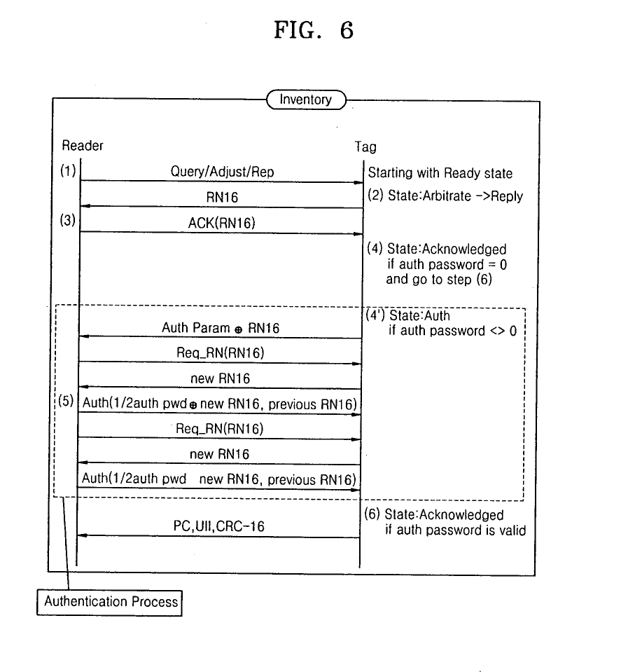

FIG. 6 illustrates a method of protecting privacy using an authentication password according to another embodiment of the present invention.

(1) An RFID reader transmits an inventory command (Query, QueryAdjust, and QueryRep) to a tag in a Ready state.

(2) When a slot-counter value of the tag is 0(RN16), the state of the tag changes from an Arbitrate state to a Reply state. When the slot-counter value is not 0, the tag waits for the QueryAdjust or QueryRep command of the reader.

(3) The RFID reader recognizes the tag as a random number value received in (2).

(4) The tag including an authentication password transmits a value obtained by performing an XOR operation with respect to a value corresponding to the authentication password and the RN16 value to the reader. The state of the tag changes from the Reply state to an Authentication state.

(5) The RFID reader transmits a command Req_RN for requesting the tag to provide a new RN16 value to the tag.

(6) The tag transmits the new RN16 value in response to the request Req_RN of the reader.

(7) The reader, which analyzes the authentication parameter, performs an operation (an XOR operation in the embodiment of FIG. 6) with respect to the top 16 bits of the authentication password corresponding to the tag and the received RN16 suitably to a method of verifying the authentication parameter and transmits a value obtained from the XOR operation to the tag.

(8) The RFID reader transmits a command Req_RN for requesting the tag to provide a new RN16 value to the tag.

(9) The tag transmits the new RN value in response to the request Req_RN of the reader.

(10) The reader performs an operation (an XOR operation in the embodiment of FIG. 6) with respect to bottom 16 bits of the authentication password and the received RN16 and transmits a value obtained from the XOR operation to the tag.

(11) The tag verifies the top 16 bits and the bottom 16 bits of the received authentication password by using the authentication password of the tag. When the verification is successful, the PC, the UII, and the CRC-16 are transmitted to the reader. The state of the tag changes from the Authentication state to an Acknowledged state. When the verification fails, the tag does not respond to the reader, and the state of the tag returns to the Arbitrate state from the Authentication state.

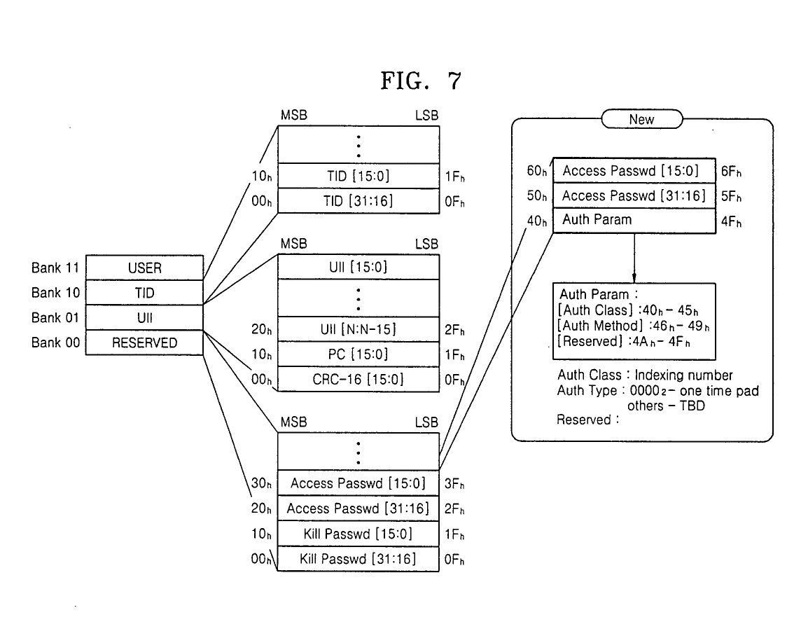

FIG. 7 illustrates a structure of a memory of a tag in which an authentication parameter and an authentication password are extended in a method of protecting privacy using an authentication password according to another embodiment of the present invention.

The tag inventory process may include an authentication process as shown in FIG. 7, according to another embodiment of the present invention.

The RFID reader recognizes the authentication password with respect to the corresponding tag through the authentication parameter (Auth Param of FIG. 7), which is transmitted from the RFID tag, and accesses a code of the RFID tag by transmitting the authentication password.

In order to protect privacy through the authentication process according to an embodiment of the present invention, as shown in FIG. 7, a RESERVED region is extended so as to include the authentication password and the authentication parameter.

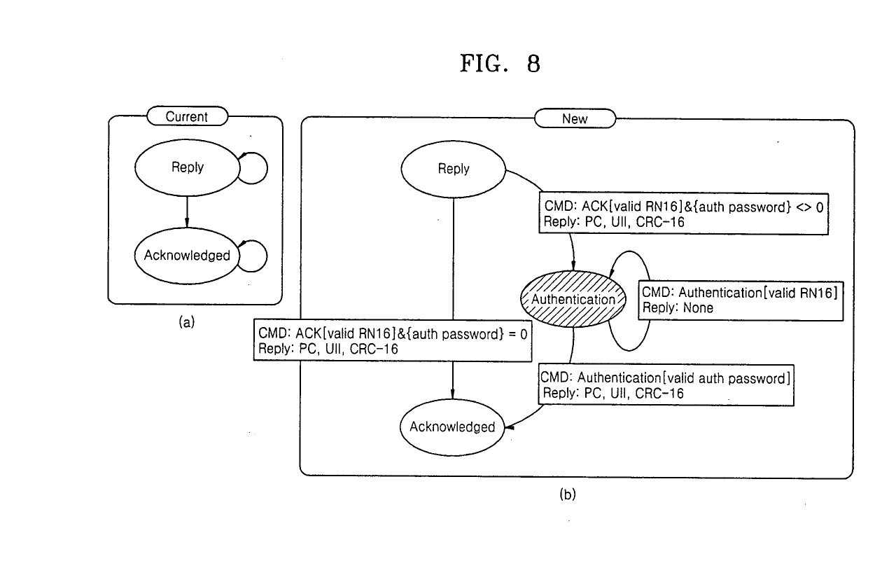

FIG. 8 illustrates a change of a state transition diagram (or a state diagram) in a method of protecting privacy using an authentication password according to another embodiment of the present invention.

When an authentication password is not included, as shown in (a) of FIG. 8, the reader can access the information on the tag by allowing the tag to pass through states of (1) Ready, (2) Arbitrate, (3) Replay, (4) Acknowledge, and (5) Open or Secured.

However, when the authentication password according to an embodiment of the present invention is included as shown in (b) of FIG. 8, the reader can access the information on the tag by allowing the tag to pass through the states of (1) Ready, (2) Arbitrate, (3) Replay, (4) Authentication, (5) Acknowledged, and (6) Open or Secured.

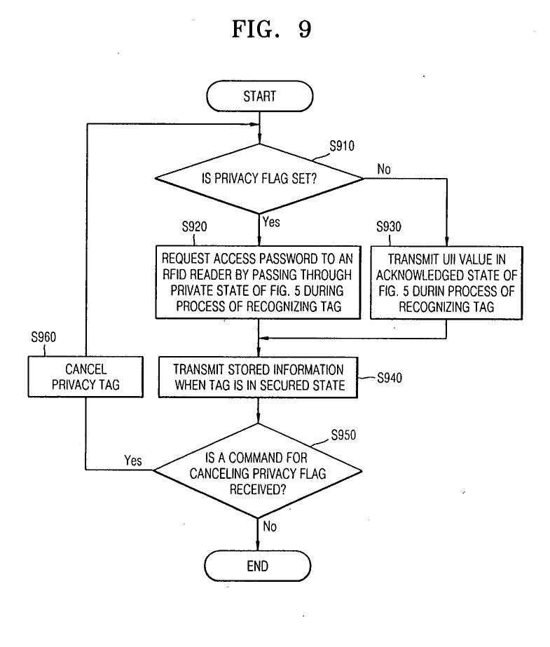

FIG. 9 is a flowchart illustrating a method of protecting privacy using a tag including a privacy tag according to an embodiment of the present invention.

A process of recognizing an electronic tag depends on whether the privacy flag is set or not (S910).

When the privacy flag is set, the electronic tag requests an access password to an RFID reader by passing through the Private state of FIG. 5 during the process of recognizing the electronic tag (S920).

When the privacy flag is not set, the electronic tag transmits a UII value in the Acknowledged state of FIG. 5 during the process of recognizing the electronic tag (S930).

The electronic tag transmits stored information, when the electronic tag is in a Secured state (S940).

The electronic tag cancels setting of the privacy flag depending on whether the electronic tag in the Secured state receives a command for canceling the privacy flag from the reader (S950 and S960).

When the privacy flag is not set, the electronic tag transmits the UII value to all types of readers. Accordingly, privacy is not protected.

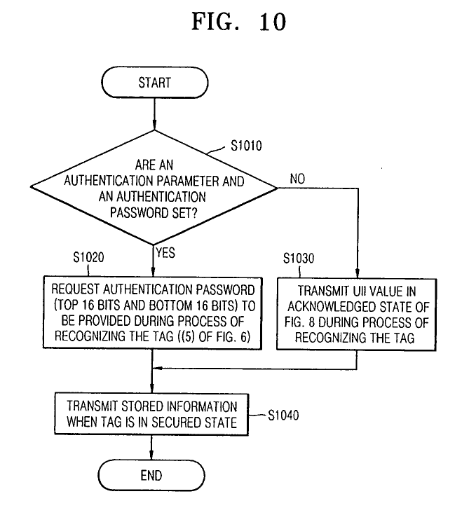

FIG. 10 is a flowchart illustrating a method of protecting privacy using an authentication password according to another embodiment of the present invention.

A process of recognizing an electronic tag depends on whether an authentication parameter and an authentication password are set or not (S1010).

When the authentication parameter and the authentication password are set, the electronic tag requests the authentication password (top 16 bits and bottom 16 bits) to be provided during the process of recognizing the electronic tag ((5) of FIG. 6) (S1020).

When the authentication parameter and the authentication password are not set, the electronic tag transmits a UII value in the Acknowledged state of FIG. 8 during the process of recognizing the electronic tag (S1030).

The electronic tag transmits stored information when the electronic tag is in a Secured state (S1040).

As described above, it is possible to protect tag data and privacy by allowing the RFID tag to transmit information to only the authorized RFID reader by using a device and a method of protecting privacy in RFID according to an embodiment of the present invention.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An electronic tag for transmitting information stored therein as a signal in a predetermined frequency band, the electronic tag comprising a privacy flag having a predetermined bit string value which is used to allow the information stored in the electronic tag to be accessed when the electronic tag receives a predetermined access password and the received password matches a previously stored password.

2. The electronic tag of claim 1, wherein the privacy flag is set or canceled depending on a received predetermined command.

3. The electronic tag of claim 1, further comprising:
a user memory region which stores predetermined application data;
a tag ID region which includes recognition information for distinguishing the electronic tag from other electronic tags; and
an item region which includes recognition information on stored items.

4. The electronic tag of claim 2, wherein the privacy flag is set or canceled when the electronic tag is in a Secured state.

5. The electronic tag of claim 2, wherein when the privacy flag is set, the electronic tag's recognition steps psss through states of (1) Ready, (2) Arbitrate, (3) Replay, (4) Private, and (5) Open or Secured.

6. The electronic tag of claim 2, wherein when the privacy flag is canceled, the electronic tag's recognition steps pass through states of (1) Ready, (2) Arbitrate, (3) Replay, (4) Acknowledged, and (5) Open or Secured.

7. The electronic tag of claim 3, wherein in the user memory region, the tag ID region, and the item ID region, a read-and-write operation can be performed.

8. The electronic tag of claim 5, wherein the electronic tag in the Private state transmits a predetermined random number value.

9. The electronic tag of claim 5, wherein the electronic tag in the Open or Secured state transmits information stored therein.

10. The electronic tag of claim 6, wherein the electronic tag in the Acknowledged state transmits information stored therein.

11. A method of protecting privacy using an electronic tag, the method comprising:
(a) setting a privacy flag including a predetermined bit string value for allowing the information stored in the electronic tag to be accessed according to a received predetermined command;
(b) determining whether authority to access the information stored in the electronic tag exists; and
(c) transmitting the information stored in the electronic tag.

12. The method of claim 11, wherein (a) is performed when the electronic tag is in a Secured state.

13. The method of claim 11, wherein the electronic tag includes a user memory region, which stores predetermined application data, a tag ID region, which includes recognition information for distinguishing the electronic tag from other electronic tags, and an item region which includes recognition information on a stored item.

14. The method of claim 11, wherein (b) comprises:
allowing the electronic tag to report that the privacy flag is set by transmitting a predetermined random number; and
receiving an access password for accessing the information stored in the electronic tag.

15. The method of claim 11, wherein in (b), the electronic tag passes through the states of (1) Ready, (2) Arbitrate, (3) Replay, (4) Private, and (5) Open or Secured.

16. The method of claim 13, wherein a read-and-write operation can be performed in the user memory region, the tag ID region, and the item ID region.

17. The method of claim 15, wherein the electronic tag in the Private state transmits a predetermined random number value.

18. The method of claim 15, wherein the electronic tag in the Open or Secured state transmits information stored therein.

19. An electronic tag, which transmits information stored therein as a signal in a predetermined frequency band, comprising:
an authentication parameter which is used to determine whether authority to access information stored in the electronic tag exists; and
an authentication password which corresponds to the authentication parameter.

20. The electronic tag of claim 19, wherein the authentication parameter and the authentication password are included in a reserved region of the electronic tag.

21. A method of protecting privacy using an electronic tag which transmits information stored therein as a signal in a predetermined frequency bandwidth, the method comprising:
setting an authentication parameter, which is used to determine whether authority to access information stored in the electronic tag exists, and an authentication password, which corresponds to the authentication parameter;
determining whether the authority to access the information stored in the electronic tag exists by examining whether a received authentication password value matches the set authentication password value; and
transmitting the information stored in the electronic tag.

22. The method of claim 21, wherein a predetermined operation in the determining of whether the authority exists is an XOR operation.

23. The method of claim 21, wherein the authentication password includes top 16 bits and bottom 16 bits of the authentication password.

24. The method of claim 23, wherein the determining of whether the authority exists comprises:
(a) transmitting a value obtained through the predetermined operation with respect to a value corresponding to the authentication parameter and a first random number;
(b) transmitting a second random number in response to a received predetermined inventory protocol;
(c) receiving a value obtained through the predetermined operation with respect to the top 16 bits of the authentication password and the second random number transmitted in (b);
(d) transmitting a third random number in response to a received predetermined inventory protocol;
(e) receiving a value obtained through the predetermined operation with respect to the bottom 16 bits of the authentication password and the third random number transmitted in (d);
(f) examining whether the top 16 bits of the authentication password are matched with the authentication password value received in (c); and
(g) examining whether the bottom 16 bits of the authentication password are matched with the authentication password value received in (e).
